(19) United States
(12) Patent Application Publication
(10) Pub. No.: US 2022/0003425 A1
(43) Pub. Date: Jan. 6, 2022

(54) Cooking Apparatus Based on Induction Heating System and Incorporating Cookware Rotation Mechanism

(71) Applicant: Kitchen Robotics Ltd, Modiin (IL)

(72) Inventor: David BEN-DAVID, Rehovot (IL)

(21) Appl. No.: 16/920,712

(22) Filed: Jul. 5, 2020

(51) Int. Cl. F24C 15/10; H05B 6/12; H05B 3/74; A47J 36/34

(52) U.S. Cl. CPC F24C 15/103; A47J 36/34; H05B 3/74; H05B 6/1209

(57) ABSTRACT

The autonomous cooking apparatus of the present invention works on the principle of induction heating and therefore incorporates an induction heating element. The improved apparatus incorporates a rotational mechanism of the cookware which imparts even heating dissemination in the cookware, apart from generating a steering motion of the cooked ingredients. The apparatus of the present invention provides an autonomous cooking apparatus for robotic cooking system or manual operation

### FIELD OF THE INVENTION

The present invention is an automated cooking apparatus using induction technique. Moreover, the apparatus allows incorporation of robotic system for cooking in a smooth manner.

### BACKGROUND OF THE INVENTION

Induction technology has been put to use in cooking since the early 1900s. In induction type cooking appliance, the maximum temperature does not as a rule, rise above the temperature of a pan. The feature has been well accepted as an excellent feature in safety and cleanliness. Further, the surface stays relatively cool so spill splatters and occasional boil-over don't burn onto the cook top, making clean-up quick and easy. Also, the absence of naked fire nor heated portion causes a much preferable operability.

The above stated features apart from providing consistent and precise temperature led to its popularity getting soared in the past few decades. The new research is primarily focused on optimization of cost and energy efficiency in cooking apart from making cooking, safe and easy. A number of prior arts exist on the various aspects of induction cooking.

### PRIOR ART

EP0069153B1 titled, “Induction heating cooking apparatus” discusses an Induction heat cooking apparatus for heating a pan or the like by induction heating. A touch-control key is used as an input unit (14), and the input unit (14) is additionally equipped with a timer function (21) such that the power source is not turned on unless at least two keys are operated correctly within a predetermined interval. In addition, a timer function (29) is provided whose operation is linked to alarm devices (36) and (37), and an alarm is automatically raised in case the pan is misaligned or there is no load. This provides a high safety induction heat cooking apparatus.

US20130153565A1 titled, “Induction Cooking Apparatus and Method of Use” talks of a cooking apparatus includes a cooking vessel, a support structure, an assortment of ferrous members and a source of electro-magnetic radiation. The ferrous members are mounted on the support structure along with food. The source of electro-magnetic radiation heats the ferrous members and enables a previously unobtainable level of precision and control in the preparation of food.

WO2016030078A1 titled, “Induction heating arrangement, method for operating an induction heating arrangement and induction hob” conceives an induction heating arrangement (1000) comprising four coils of a smaller diameter (1100, . . . , 1400) and a coil having a larger diameter (1500). The coils are arranged on a first plane (2100) and on a second plane (2200). In order to adapt a cooking area (1600) to the size of a pot, either the larger coil (1500) or one or more of the smaller coils (1100, 1400) are operated. A power supply circuitry (2400) is shared between the coils of the two planes and a selector (2300) takes care of disconnecting a respective coil of the plane of coils that is not operated in order to avoid coupling and interference and loss of energy. The guiding elements of the magnetic flux (1110, 1115, 1540) are used to confine the magnetic field in the area of the pot. The method of operating the induction heating arrangement takes care of efficient energy use, and an induction hob (3000) includes the induction heating arrangement.

Whereas, the granted inventions discusses safety, efficiency, ease of use but none of these applies automatic/robotic interferences in optimizing efficiency as also safety. The present inventive idea is an effort in that direction.

### SUMMARY OF THE INVENTION

An aspect of the present invention is to provide a cooking apparatus, incorporated with cookware rotation mechanism and based on induction heating system.

A still further aspect of the invention is to provide a cooking apparatus, which may be used both as stand-alone and also can be incorporated in automated or robotic systems.

Another aspect of the invention is to generate a rotational movement of the cookware which introduces a steering motion to the content of the cookware for even heat dissemination.

A further aspect of the invention is to sustain, the cookware flat base parallel to the induction element thereby preventing the drop of the magnetic field and maintaining the heating efficiency.

A still further aspect of the invention is to sustain a gap between the induction element ceramic glass and the cookware flat base thereby avoiding friction and wear.

Another aspect of the present invention is to enable simple mounting and dismounting of the cookware, either manually or automatically, by a single line of movement.

A still further aspect of the present invention is the adjustment of the cooking angle, while sustaining a precise distance from the cookware flat base and the induction element and also enabling heating and rotation of the cookware.

Another aspect of the present invention is to provide a cooking apparatus with optimized rotational movement control which is achieved by the controller and the processor of the cooking apparatus.

Another aspect of the present invention is the provision of utilizing a variety of cookware.

A still further aspect of the present invention is that, the mounting of the cookware can be done both manually as well as automatically.

Another aspect of the present invention is the ingredients steering on, generated by the cookware rotation during the induction heating process.

### BRIEF DESCRIPTION OF THE DRAWINGS

FIG. 1 is the perspective view of the prior art depicting the induction unit ceramic glass, the cookware rotation mechanism friction wheels and the spring-loaded idler wheels.

FIG. 2 is a front view of the prior art depicting the electric motor used for generating the rotational movement of cookware.

FIG. 3 illustrates the induction unit mounting support of the present invention for enabling the adjustment of the cooking angle.

FIG. 4 is a cross-section view of the induction unit and the rotational mechanism illustrating the induction heating element and the cookware rotation mechanism pulleys, sprockets and timing belt.

FIG. 5 isometric view of a cookware being positioned in place.

FIG. 5a side view of the cookware being positioned, showing the cookware round ring prior positioning on the friction wheels datum plane.

FIG. 5b detailed side view of FIG. 5a

### REFERENCE NUMERALS

100 induction unit ceramic glass

101 friction wheels

102 spring loaded idler wheels

301 electric motor

302 induction unit mounting support

401 induction heating element

402 cookware rotation mechanism comprising of pulleys, sprockets and timing belt.

501 cookware

501a cookware positioning round element

502 indication of contact point between cookware round element, friction wheels and spring loaded idlers

### DETAILED DESCRIPTION OF THE PREFERRED EMBODIMENTS

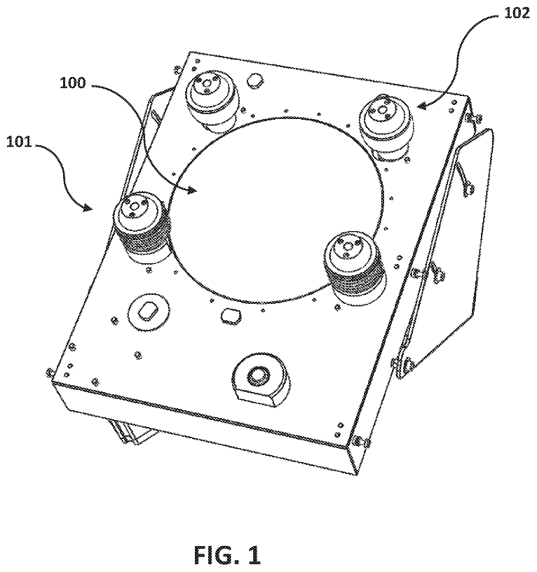

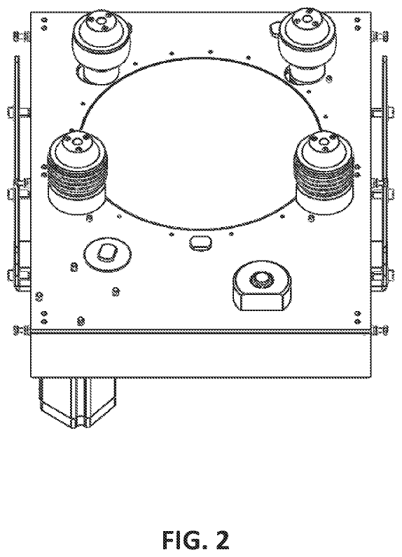

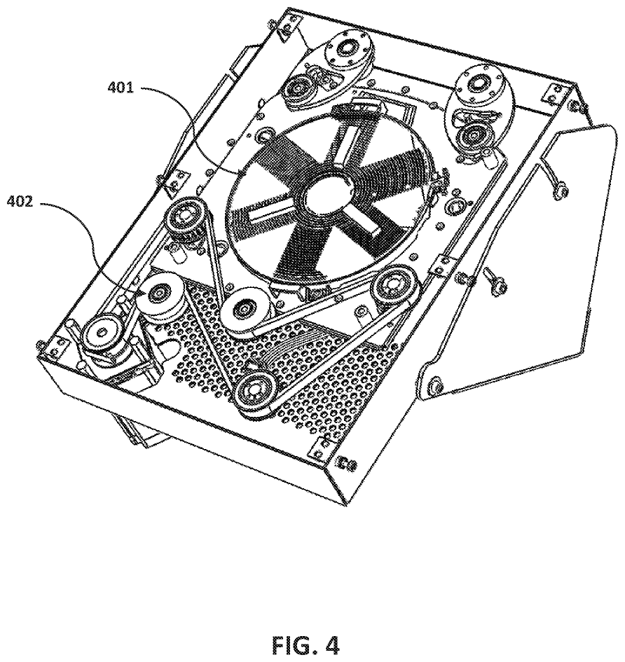

The following disclosure describes several embodiments of food heating and/or cooking devices. Specific details of several embodiments of the present disclosure are described below with reference to FIGS. 1 to 5 to provide a thorough understanding of the embodiments. Other details describing well-known structures and systems often associated with heating or cooking food, however, are not set forth below to avoid unnecessarily obscuring the description of the various embodiments. Accordingly, those of ordinary skill in the art will understand that the invention may have other embodiments in addition to those described below. Such embodiments may include other elements and features in addition to those described below, or they may lack one or more of the features or elements described below.

The autonomous cooking apparatus of the present invention, works on the principle of induction heating and therefore incorporates an induction heating element. The improved apparatus, incorporates a rotational mechanism of the cookware which imparts even heating dissemination in the cookware, apart from generating a steering motion of the cooked ingredients. The apparatus of the present invention provides an autonomous cooking apparatus for robotic cooking system or manual operation.

Referring to FIGS. 1-5, to achieve the above, the cooking apparatus is provided with an electric motor (301), a processor, a controller, friction wheels (101), spring loaded idler wheels (102), pulleys, sprockets and timing belt (402), cookware positioning element (501a).

Rotational Movement

The rotation of the cookware automizes a hand steering motion for even heat dissemination. The rotational movement is generated by an electric motor (301), invoked by a controller and receiving commands from a processor. The power from the electric motor is transferred by a timing belt through a series of pulleys (402) to friction wheels (101). The outer diameter of the friction wheels (101) which are made of heat resistant high friction material, transfers the tangential friction force to the cookware. This is due to the fact, that the outer diameter of the friction wheels (101), are pressed against the outer diameter of the cookware, generating the required tangential force to rotate it. The pressure required is applied by spring loaded idler wheels (102), across the center of the cookware. Also the normal force essential for generating the tangential friction forces is applied by the spring-loaded idler wheels (102), mounted across the cookware.

It is to be understood that the rotation direction as well as the rotational speed might vary between recipes cooked. Further, the speed and direction can be preadjusted and sustained during the cooking process, or altered, depending on the recipe requirements.

In an embodiment of the present invention, the rotational speed and movement as well as the direction is optimized and controlled. This is achieved by the controller of the apparatus which invokes the motor with the desired speed. The controller itself receives precise commands from the processor with regards to the rotational speed and direction to be maintained depending upon the type of cookware, the ingredients and the recipe to be cooked, the inputs of which is received by the processor.

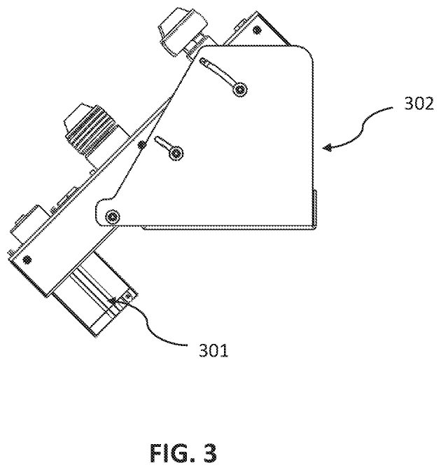

In another embodiment of the present invention, the cooking apparatus provides for an adjustable cooking plane angle. The cooking plane can be inclined for cooking optimization, while sustaining the induction efficiency and the rotational movement of the cookware, enabling heating and rotation of the cookware, while sustaining a precise distance from the cookware flat base and the induction element. The angle of inclination can be manually preadjusted. The inclination of the cooking plane can be achieved by an induction unit mounting support (302) as shown in FIG. 3.

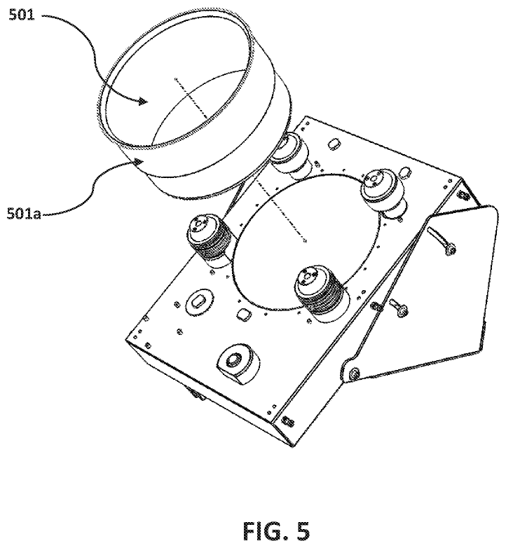

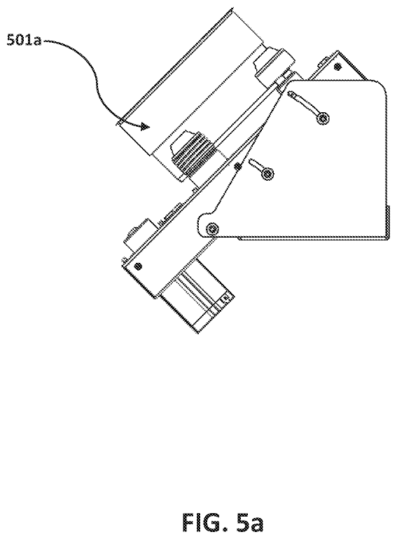

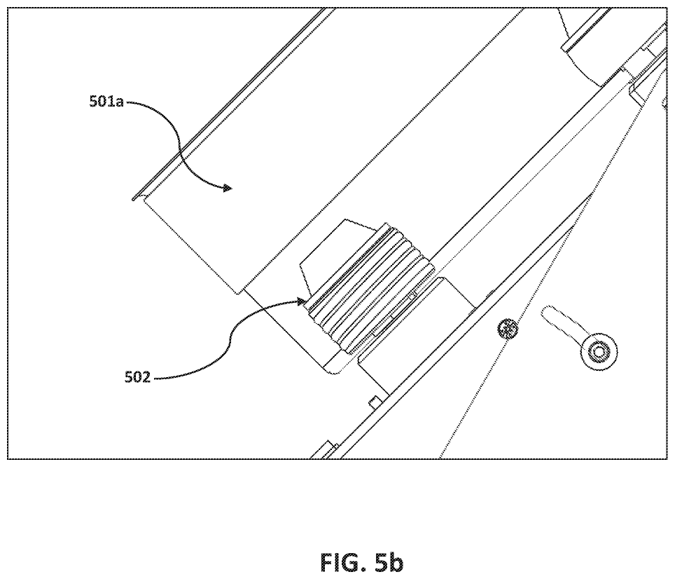

In an embodiment of the present invention, and referring to FIGS. 5, 5a and 5b the flat base of the cookware (501) parallel to the induction element for maintaining heating efficiency is sustained in the entire cooking process, in order to avoid a rapid drop of the magnetic field generated by the induction element. This is achieved by a positioning round element (501a) attached to the cookware (501) as depicted in which serves as a datum for sustaining the distance between the cookware flat base and the induction element, thus enabling to use a range of depths of the cookware.

The friction wheels (101) and spring-loaded idler wheels (102) contain an adjustable element, defining a 4 point datum, served as a positioning for the cookware. The cookware (501) is positioned, automatically or manually, in contact with at least 3 of the 4 datum points. The adjustable element described above is calibrated to achieve a precise and sustainable distance between the cookware flat base and the induction ceramic glass surface. Once calibrated, the distance is sustainable, while positioning and removing the cookware from the apparatus.

Also the distance between the cookware flat base and the induction element can be preadjusted and sustained during the rotational movement, preventing the drop of the magnetic field and maintaining the heating efficiency. The maintenance of gap between the induction element ceramic glass and the cookware flat base is also important for avoiding friction and wear. The maintenance of the gap also allows a range of cookware having varying depths and diameter to be used for induction cooking.

The present apparatus also allows cookware of varying texture and surface finishes to be used for cooking since the texture and the surface finish of the cookware have little effect on the tangential friction forces generated by the friction wheels since the spring-loaded idler wheels applies normal forces on the cookware's outer diameter which increases the range of cookware that can be used on the apparatus.

An embodiment of the present apparatus comprises of spring-loaded idler wheels which are flexible and increases the placement tolerance requirement which enables both manual and automatic cookware mounting. The cookware can be mounted by a single directional linear motion, generated manually by hand or automatically by a motion mechanism. Such motion mechanism might be a motor driven linear motion guide, gripping the cookware, or a pneumatic drive, or a pneumatic piston, or a linear motor, or any other component generating a linear motion. The above described mechanism will be capable of positioning the cookware precisely and perpendicularly to the induction ceramic glass and performing a linear motion, while maintaining a real time position control. The mechanism will position the cookware in a predefined position.

The spring-loaded idler wheels enables simple mounting and dismounting of the cookware, either manually or automatically, by a single line of movement. Since, spring loaded idler wheels tolerate a predefined amount of positioning error, thereby easing the manual mounting operation or motion precision requirements from the peripheral subsystems.

In an embodiment of the present invention, the cooking apparatus can be operated as a standalone induction apparatus as in prior art or it can also be operated as a subsystem of an automated food preparation apparatus. A series of independent cooking units can be operated and controlled by a processor, adjusting the rotational speed and direction, as well as the power, individually. The inclined cooking angle can be individually adjusted as well, to match the requirements for variety of recipes cooked.

The present disclosed subject flatter may be a system, a method, and/or a computer program product. The computer program product may include a computer readable storage medium (or media) having computer readable program instructions thereon for causing a processor to carry out aspects of the present disclosed subject matter. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter. Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A cooking apparatus based on induction heating element incorporating a rotation mechanism, the apparatus comprising:
an induction unit ceramic glass;
at least one friction wheels;
at least one spring loaded idler wheels;
at least one electric motor;
an induction mounting support;
means for initiating and maintaining cookware rotation;
means for maintaining distance between cookware flat base and induction element;
a control unit; and
a processor
wherein
the said processor receives inputs from the cooking apparatus of the type of ingredients to be used, the recipe to be cooked, and the type of cookware to be used and accordingly send information to the control unit, the speed with which the cookware is to be rotated;
wherein
the said control unit invokes the electric motor for initiating the rotation mechanism.

2. The cooking apparatus of claim 1, wherein the said means for initiating and maintaining the cookware rotation comprises of pulleys, sprockets and timing belt.

3. The cooking apparatus of claim 1, wherein the said electric motor is invoked by the said controller which rotates the cookware.

4. The cooking apparatus of claim 1, wherein the said sprockets, timing belt, pulleys, friction wheels and spring-loaded idler wheels together work in tandem for the rotation mechanism of the cookware.

5. The cooking apparatus of claim 1, wherein the outer diameter of the said friction wheels is pressed against the outer diameter of the cookware, thereby generating the required tangential force required to rotate the cookware.

6. The cooking apparatus of claim 1, wherein the said spring-loaded idler wheels applies normal forces which generate the tangential frictional forces essential for rotating the cookware.

7. The cooking apparatus of claim 1, wherein the outer diameter of the friction wheels is made of heat resistant high friction material.

8. The cooking apparatus of claim therein the heat resistant high friction material is Silicone.

9. The cooking apparatus of claim 1, wherein the heat resistant high friction material is Viton

10. The cooking apparatus of claim 1, wherein the said mounting support, functions in providing the desired inclined angle to the cooking plane.

11. The cooking apparatus of claim 1, wherein the means for maintaining distance between the flat base of the cookware and the induction element, is a positioning round element attached to the cookware. Adjusted in para 046

12. The cooking apparatus of claim 1, wherein the said cooking apparatus may be operated as a subsystem of an automated cooking apparatus.

13. The cooking apparatus of claim 1, wherein the said cooking apparatus may be operated as a standalone cooking apparatus.

14. The cooking apparatus of claim 1, wherein the said spring-loaded idler wheels are flexible and increases the placement tolerance requirement enabling mounting of the cookware both manually and automatically.

15. The cooking apparatus of claim 11, wherein the cooking angle, the rotational speed and the direction is controlled and operated by the processor.

16. A method of precise cooking and even heating of the cookware by induction heating, the method comprising:
generating a magnetic field;
generating the rotation of the cookware;
maintaining a precise distance between the heating element and the cookware for even heat dissemination;
controlling the rotational speed and direction of the cookware which varies during the cooking process depending upon the ingredients of the recipe and the type of cookware;
optimizing and controlling the rotational speed, movement and direction of the cookware;
providing an inclination of cooking plane.

17. The method of claim 16, wherein the rotation of the cookware is generated by the electric motor, invoked by the controller and which receives commands from the processor.

18. The method of claim 17, wherein the generation of rotation of the cookware further comprises the step of transferring the power from the electric motor to the said frictional wheels by the said timing belt through a series of pulleys, which intern transfers the tangential frictional force to the cookware.

19. The method of claim 16, wherein a precise distance between the heating element and the cookware for even heat dissemination is achieved by a positioning round element attached to the cookware serving as a datum for sustaining the distance between the cookware flat base and the induction element.

20. The method of claim 16, wherein an inclination of the cooking plane is provided by an induction unit mounting support.
